(19) United States
(12) Patent Application Publication
(10) Pub. No.: US 2023/0418513 A1
(43) Pub. Date: Dec. 28, 2023

(54) STORAGE DEVICE AND METHOD OF OPERATING THE STORAGE DEVICE

(71) Applicant: SK hynix Inc., Icheon-si Gyeonggi-do (KR)

(72) Inventor: Byoung Sung YOU, Icheon-si Gyeonggi-do (KR)

(73) Assignee: SK hynix Inc., Icheon-si Gyeonggi-do (KR)

(21) Appl. No.: 18/464,073

(22) Filed: Sep. 8, 2023

Related U.S. Application Data
(62) Division of application No. 17/202,988, filed on Mar. 16, 2021.

(30) Foreign Application Priority Data
Sep. 14, 2020 (KR) 10-2020-0117898

(51) Int. Cl. G06F 3/06

(52) U.S. Cl. CPC G06F 3/0655; G06F 3/0604; G06F 3/0679

(57) ABSTRACT

A storage device includes a nonvolatile memory device including a memory cell array, a page buffer, and a map buffer and a memory controller. The memory cell array is configured to store a plurality of map entries each indicating a mapping relationship between a logical address and a physical address each. A page buffer is configured to store the plurality of map entries stored in the nonvolatile memory device having a map buffer index. The memory controller is configured to provide a first map read command and a second map read command to the nonvolatile memory device to convert a logical address from a host into a physical address and perform operation.

### CROSS-REFERENCE TO RELATED APPLICATION

The present application is a divisional application of U.S. patent Ser. No. 17/202,988, filed on Mar. 16, 2021, which claims priority under 35 U.S.C. § 119(a) to Korean patent application number 10-2020-0117898, filed on Sep. 14, 2020, in the Korean Intellectual Property Office, the entire disclosure of which is incorporated herein by reference.

### BACKGROUND

### 1. Technical Field

The present disclosure relates to an electronic device, and more particularly, to a storage device and a method of operating the storage device.

### 2. Related Art

A storage device is a device that stores data under control of a host device. The storage device may include a memory device storing data and a memory controller controlling the memory device. The memory device may be classified into a volatile memory device and a nonvolatile memory device.

The volatile memory device may store data only while receiving power from a power source. When the power supply is cut off, the data stored in the volatile memory device may be lost. The volatile memory device may include a static random access memory (SRAM), a dynamic random access memory (DRAM), and the like.

The nonvolatile memory device may be a device in which the data is not lost even though power of the power source is cut off. The nonvolatile memory device may include a read only memory (ROM), a programmable ROM (PROM), an electrically programmable ROM (EPROM), an electrically erasable and programmable ROM (EEPROM), a flash memory, and the like.

### SUMMARY

A storage device according to an embodiment of the present disclosure may include a nonvolatile memory device including a memory cell array configured to store a plurality of map entries each indicating a mapping relationship between a logical address and a physical address, and a page buffer configured to store the plurality of map entries, a volatile memory device configured to be loaded with map entries, from the plurality of map entries, stored in the nonvolatile memory device, and a memory controller configured to control the nonvolatile memory device to convert a logical address provided from a host into a physical address and perform an operation corresponding to a request on the physical address, in response to the request provided from the host, and the page buffer may include a map buffer configured to store first map entries among the plurality of map entries, and a map index buffer configured to store second map entries arranged in an order based on a hit count corresponding to the number of times a map entry corresponding to the logical address provided from the host among the first map entries is hit.

A method of operating a storage device according to another embodiment of the present disclosure may include reading first map entries and second map entries among a plurality of entries stored in a memory cell array, storing the first map entries in a map buffer included in a page buffer, and sequentially storing the second map entries in a map index buffer included in the page buffer according to a hit count corresponding to the number of times a map entry is hit, and determining whether a search map entry corresponding to a logical address received from a host is searched in the map index buffer.

### BRIEF DESCRIPTION OF THE DRAWINGS

FIG. 1 is a diagram illustrating a storage system according to an embodiment of the present disclosure.

FIG. 2 is a diagram illustrating a nonvolatile memory device according to an embodiment of the present disclosure.

FIG. 3 is a diagram illustrating an embodiment of a memory block.

FIG. 4 is a diagram illustrating a page buffer according to an embodiment of the present disclosure.

FIG. 5 is a diagram illustrating a map buffer shown in FIG. 4.

FIG. 6 is a diagram illustrating a map index buffer shown in FIG. 4.

FIG. 7 is a diagram illustrating an embodiment of performing a map update according to an embodiment of the present disclosure.

FIG. 8 is a diagram illustrating another embodiment of performing a map update according to an embodiment of the present disclosure.

FIG. 9 is a diagram illustrating still another embodiment of performing a map update according to an embodiment of the present disclosure.

FIG. 10 is a diagram illustrating region division of a memory cell array according to a program operation.

FIG. 11 is a flowchart illustrating a method of operating a storage device according to an embodiment of the present disclosure.

FIG. 12 is a diagram illustrating a map caching buffer according to an embodiment of the present disclosure.

FIG. 13 is a diagram illustrating a memory controller according to an embodiment of the present disclosure.

FIG. 14 is a block diagram illustrating a memory card system to which a storage device according to an embodiment of the present disclosure is applied.

FIG. 15 is a block diagram illustrating a solid state drive (SSD) system to which a storage device according to an embodiment of the present disclosure is applied.

FIG. 16 is a block diagram illustrating a user system to which a storage device according to an embodiment of the present disclosure is applied.

### DETAILED DESCRIPTION

Specific structural or functional descriptions of embodiments according to the concept which are disclosed in the present specification or application are illustrated only to describe the embodiments according to the concept of the present disclosure. The embodiments according to the concept of the present disclosure may be carried out in various forms and the descriptions are not limited to the embodiments described in the present specification or application.

An embodiment of the present disclosure is to provide a storage device improving performance and an operation speed of storing map data, and a method of operating the storage device. According to the present technology, a storage device improving performance and an operation speed of storing map data, and a method of operating the same are provided.

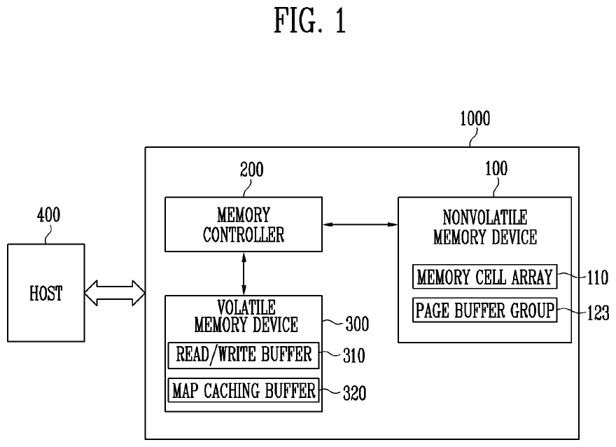

FIG. 1 is a diagram illustrating a storage system according to an embodiment of the present disclosure.

Referring to FIG. 1, the storage system may be implemented as a personal computer (PC), a data center, a corporate data storage system, a data processing system including a direct attached storage (DAS), a data processing system including a storage area network (SAN), and a data processing system including a network attached storage (NAS), or the like.

The storage system may include a storage device 1000 and a host 400.

The storage device 1000 may be a device that stores data according to a request of the host 400 such as a cellular phone, a smartphone, an MP3 player, a laptop computer, a desktop computer, a game player, a TV, a tablet PC, or an in-vehicle infotainment system.

The storage device 1000 may be manufactured as one of various types of storage devices according to a host interface that is a communication method with the host 400. For example, the storage device 1000 may be configured as any one of various types of storage devices such as an SSD, a multimedia card in a form of an MMC, an eMMC, an RS-MMC and a micro-MMC, a secure digital card in a form of an SD, a mini-SD and a micro-SD, a universal serial bus (USB) storage device, a universal flash storage (UFS) device, a personal computer memory card international association (PCMCIA) card type storage device, a peripheral component interconnection (PCI) card type storage device, a PCI express (PCI-E) card type storage device, a compact flash (CF) card, a smart media card, and a memory stick.

The storage device 1000 may be manufactured as any one of various types of packages. For example, the storage device 1000 may be manufactured as any one of various types of package types, such as a package on package (POP), a system in package (SIP), a system on chip (SOC), a multi-chip package (MCP), a chip on board (COB), a wafer-level fabricated package (WFP), and a wafer-level stack package (WSP).

The storage device 1000 may include a nonvolatile memory device 100, a memory controller 200, and a volatile memory device 300.

The nonvolatile memory device 100 may operate in response to control of the memory controller 200. For example, the nonvolatile memory device 100 may receive a command and an addresses from the memory controller 200 and access a memory cell selected by the address among memory cells (not shown). The nonvolatile memory device 100 may perform an operation instructed by the command on the memory cell selected by the address.

The command may be, for example, a program command, a read command, or an erase command, and the operation instructed by the command may be, for example, a program operation (or a write operation), a read operation, or an erase operation.

The program operation may be an operation in which the nonvolatile memory device 100 stores write data provided from the host 400 in response to control of the memory controller 200.

For example, the nonvolatile memory device 100 may receive the program command, an address, and data, and program the data in a memory cell selected by the address. Here, data to be programmed in the selected memory cell may be defined as the write data. Here, the address may be a physical address corresponding to a logical address provided from the host 400.

For example, the nonvolatile memory device 100 may receive the read command and an address, and read data from a region selected by the address in the memory cell array (not shown). The data to be read from the selected region among data stored in the nonvolatile memory device 100 may be defined as read data. Here, the address may be the physical address corresponding to the logical address provided from the host 400.

The erase operation may be an operation in which the nonvolatile memory device 100 erases the data stored in the nonvolatile memory device 100 in response to the control of the memory controller 200.

For example, the nonvolatile memory device 100 may receive the erase command and an address, and erase data stored in a region selected by the address. Here, the address may be the physical address corresponding to the logical address provided from the host 400.

As an embodiment, the nonvolatile memory device 100 may be implemented as a flash memory. For example, the flash memory may include a NAND flash memory, a vertical NAND flash memory, and a NOR flash memory.

In the present specification, for convenience of description, it is assumed that the nonvolatile memory device 100 is a NAND flash memory.

The nonvolatile memory device 100 may store the write data under the control of the memory controller 200, or read the stored read data and provide the read data to the memory controller 200 under the control of the memory controller 200.

The nonvolatile memory device 100 may include a memory cell array 110.

The memory cell array 110 may include a plurality of memory blocks (not shown). The memory block may be a unit that performs an erase operation of erasing data.

The memory block may include a plurality of pages (not shown). The page may be a unit that performs the program operation of storing the write data or the read operation of reading the stored read data.

In an embodiment, the memory cell array 110 may store a plurality of map entries. The map entry may be data indicating a mapping relationship between a logical address and a physical address, respectively. The plurality of map entries may be stored in a system block (not shown) among a plurality of memory blocks. In the present specification, “map entry” or “map data” may have the same meaning.

The nonvolatile memory device 100 may include a page buffer group 123.

During the program operation, the page buffer group 123 may receive and temporarily store the write data, and transmit the temporarily stored write data to the memory cell array 110. In addition, during the read operation, the page buffer group 123 may read the read data stored in the memory cell array 110, and may output the read data to the memory controller 200.

The page buffer group 123 may read and temporarily store the map entry stored in the memory cell array 110.

The memory controller 200 may control an overall operation of the storage device 1000.

When power is applied to the storage device 1000, the memory controller 200 may execute firmware. When the nonvolatile memory device 100 is a flash memory device, the firmware may include a host interface layer, a flash translation layer, and a flash interface layer.

The host interface layer may control an operation between the host 400 and the memory controller 200.

The flash translation layer may convert a logical address provided from the host 400 into a physical address. To this end, the memory controller 200 may store the map entry that is a correspondence relationship between the logical address and the physical address. For example, the flash translation layer may load some map entries among the plurality of map entries stored in the memory cell array 110 to a map caching buffer 320 included in the volatile memory device 300. In addition, the flash translation layer may load map entries among the plurality of map entries stored in the memory cell array 110 to the page buffer group 123 included in the nonvolatile memory device 100. Here, a set of the some map entries may be referred to as a map segment.

In an embodiment, the memory controller 200 may control the nonvolatile memory device 100 to read the map entry stored in the page buffer group 123. To this end, the memory controller 200 may provide a map read command commanding to read the map entry stored in the page buffer group 123 to the nonvolatile memory device 100.

The flash interface layer may control communication between the memory controller 200 and the nonvolatile memory device 100.

The memory controller 200 may control the nonvolatile memory device 100 to perform the program operation, the read operation, and the erase operation, respectively, in response to a write request, a read request, and an erase request of the host 400.

During the program operation, the memory controller 200 may provide the program command, the physical addresses, and the write data to the nonvolatile memory device 100.

During the read operation, the memory controller 200 may provide the read command and the physical address to the nonvolatile memory device 100.

During the erase operation, the memory controller 200 may provide the erase command and the physical address to the nonvolatile memory device 100.

The memory controller 200 may generate the command, the addresses, and data autonomously regardless of a request provided from the host 400. The memory controller 200 may transmit the autonomously generated command, address, and data to the nonvolatile memory device 100.

For example, the memory controller 200 may generate a command, an addresses, and data for performing a background operation. In addition, the memory controller 200 may provide the command, the address, and the data to the nonvolatile memory device 100.

The background operation may be at least one of wear leveling, read reclaim, or garbage collection.

The wear leveling may mean, for example, static wear leveling, dynamic wear leveling, and the like. The static wear leveling may mean an operation of storing the number of times memory blocks are erased and moving cold data included in a memory block having the least number of times memory blocks are erases to a memory block having the largest number of times memory blocks are erased. Here, the cold data may be data in which an erase operation or a write operation hardly occurs. The dynamic wear leveling may mean an operation of storing the number of times memory blocks are erased and programming data in a memory block having the least number of erase times.

The read reclaim may mean an operation of moving data stored in a memory block to another memory block before an uncorrectable error occurs in data stored in a memory block.

The garbage collection may mean an operation of copying valid data included in a bad block among memory blocks to a free block and erasing invalid data included in the bad block. Here, copying the valid data included in the bad block to the free block may mean moving the valid data included in the bad block to the free block.

The memory controller 200 may control two or more memory devices 100. In this case, the memory controller 200 may control the memory devices 100 according to an interleaving method to improve operation performance.

The interleaving method may be a method of controlling operations of two or more memory devices 100 to overlap.

The volatile memory device 300 may include a read/write buffer 310 and the map caching buffer 320.

During the program operation, the read/write buffer 310 may temporarily store the write data received from the host 400, and transmit the temporarily stored write data to the nonvolatile memory device 100. In addition, during the read operation, the read/write buffer 310 may temporarily store the read data received from the nonvolatile memory device 100, and transmit the temporarily stored read data to the host 400.

The map caching buffer 320 may receive the map entry from the nonvolatile memory device 100 and temporarily store the map entry. For example, when the storage device 1000 is powered up, the nonvolatile memory device 100 may read some map entries among the plurality of map entries stored in the memory cell array 110 in a map segment unit, and transmit the read map segment to the memory controller 200. The memory controller 200 may store the map entry loaded from the nonvolatile memory device 100 in the map caching buffer 320 in the map segment unit.

For example, the volatile memory device 300 may include a double data rate synchronous dynamic random access memory (DDR SDRAM), a low power double data rate4 (LPDDR4) SDRAM, a graphics double data rate (GDDR) SDRAM, a low power DDR (LPDDR), a Rambus dynamic random access memory (RDRAM), or the like.

The host 400 may communicate with the storage device 1000 through an interface (not shown).

The interface may be implemented with a serial advanced technology attachment (SATA) interface, a SATA express (SATA express) interface, a serial attached small computer system interface (SAS) interface, a peripheral component interconnect express (PCIe) interface, a nonvolatile memory express (NVMe) interface, an advanced host controller interface (AHCI), or a multimedia card interface. However, the interface is not limited thereto.

The host 400 may communicate with the storage device 1000 to store the write data in the storage device 1000 or obtain the read data stored in the storage device 1000.

In an embodiment, the host 400 may provide the write request to the storage device 1000 for requesting to store the write data in the storage device 1000. In addition, the host 400 may provide the write request, the write data, and a logical address for identifying the write data to the storage device 1000.

The storage device 1000 may store the write data provided by the host 400 in the nonvolatile memory device 100 in response to the write request provided from the host 400 and provide a response that the storage is completed to the host 400.

In an embodiment, the host 400 may provide the read request to the storage device 1000 for requesting to provide the data stored in the storage device 1000 to the host 400. In addition, the host 400 may provide a read request and a read address to the storage device 1000.

The storage device 1000 may read the read data corresponding to the read address provided by the host 400 from the nonvolatile memory device 100 in response to the read request provided from the host 400 and provide the read data to the host 400 as a response to the read request.

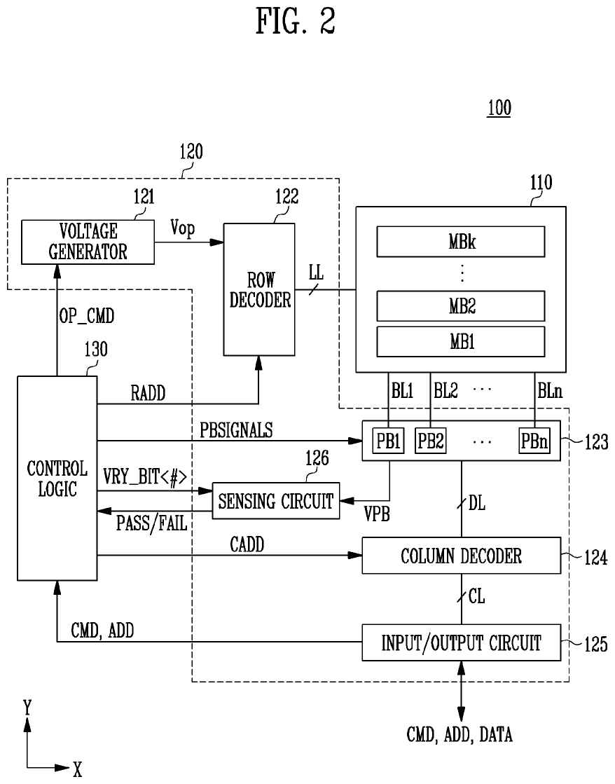

FIG. 2 is a diagram illustrating a nonvolatile memory device according to an embodiment of the present disclosure.

Referring to FIGS. 1 and 2, the nonvolatile memory device 100 may include the memory cell array 110, a peripheral circuit 120, and control logic 130. The control logic 130 may be implemented as hardware, software, or a combination of hardware and software. For example, the control logic 130 may be a control logic circuit operating in accordance with an algorithm and/or a processor executing control logic code.

The memory cell array 110 may include a plurality of memory blocks MB1 to MBk (k is a positive integer). Here, the number of the plurality of memory blocks MB1 to MBk is only an example for describing embodiments of the present disclosure, but is not limited thereto.

Each of the memory blocks MB1 to MBk may be connected to local lines LL and bit lines BL1 to BLn (n is a positive integer).

The local lines LL may be connected to a row decoder 122.

The local lines LL may be connected to each of the memory blocks MB1 to MBk.

Although not shown, the local lines LL may include a first select line, a second select line, and a plurality of word lines arranged between the first select line and the second select lines.

Although not shown, the local lines LL may further include dummy lines arranged between the first select line and the word lines, dummy lines arranged between the second select line and the word lines, and pipelines.

The bit lines BL1 to BLn may be commonly connected to the memory blocks MB1 to MBk.

The memory blocks MB1 to MBk may be implemented as a two-dimensional or three-dimensional structure.

For example, in the memory blocks MB1 to MBk of the two-dimensional structure, memory cells may be arranged in a direction parallel to a substrate.

For example, in the memory blocks MB1 to MBk of the three-dimensional structure, memory cells may be stacked on a substrate in a vertical direction.

The peripheral circuit 120 may include a voltage generator 121, the row decoder 122, a page buffer group 123, a column decoder 124, an input/output circuit 125, and a sensing circuit 126.

The voltage generator 121 may generate various operation voltages Vop used for the program operation, the read operation, and the erase operation in response to an operation command OP_CMD. In addition, the voltage generator 121 may selectively discharge the local lines LL in response to the operation command OP_CMD. For example, the voltage generator 121 may generate a program voltage, a verify voltage, pass voltages, a turn-on voltage, a read voltage, an erase voltage, a source line voltage, and the like under control of the control logic 130.

As an embodiment, the voltage generator 121 may regulate an external power voltage to generate an internal power voltage. The internal power voltage generated by the voltage generator 121 is used as an operation voltage of the nonvolatile memory device 100.

As an embodiment, the voltage generator 121 may generate a plurality of voltages using an external power voltage or an internal power voltage. For example, the voltage generator 121 may include a plurality of pumping capacitors that receive the internal power voltage, and may generate the plurality of voltages by selectively activating the plurality of pumping capacitors in response to the control of the control logic 130. The plurality of generated voltages may be supplied to the memory cell array 110 by the row decoder 122.

The row decoder 122 may transfer the operation voltages Vop to the local lines LL in response to a row address RADD. The operation voltages Vop may be transferred to selected memory blocks MB1 to MBk through the local lines LL.

For example, during the program operation, the row decoder 122 may apply the program voltage to a selected word line and a program pass voltage of a level less than that of the program voltage to unselected word lines. During the program verify operation, the row decoder 122 may apply the verify voltage to the selected word line and a verify pass voltage greater than the verify voltage to the unselected word lines.

During the read operation, the row decoder 122 may apply the read voltage to the selected word line, and apply a read pass voltage greater than the read voltage to the unselected word lines.

During the erase operation, the row decoder 122 may select one memory block according to a decoded address. During the erase operation, the row decoder 122 may apply a ground voltage to word lines connected to the selected memory block.

The page buffer group 123 may include first to n-th page buffers PB1 to PBn. The first to n-th page buffers PB1 to PBn may be connected to the memory cell array 110 through the first to n-th bit lines BL1 to BLn, respectively. The first to n-th page buffers PB1 to PBn may operate in response to the control of the control logic 130.

Specifically, the first to n-th page buffers PB1 to PBn may operate in response to page buffer control signals PBSIGNALS. For example, the first to n-th page buffers PB1 to PBn may temporarily store data received through the first to n-th bit lines BL1 to BLn, or may sense a voltage or a current of the first to n-th bit lines BL1 to BLn during the read operation or the verify operation.

During the program operation, when the program voltage is applied to the selected word line, the first to n-th page buffers PB1 to PBn may transfer data DATA received through the column decoder 124 and the input/output circuit 125 to the selected memory cell through the first to n-th bit lines BL1 to BLn. The memory cells of the selected page are programmed according to the transferred data DATA. The memory cell connected to the bit line to which a program permission voltage (for example, a ground voltage) is applied may have an increased threshold voltage. The threshold voltage of the memory cell connected to the bit line to which a program inhibit voltage (for example, a power voltage) is applied may be maintained.

During the verify operation, the first to n-th page buffers PB1 to PBn may sense data stored in the memory cells selected through the first to n-th bit lines BL1 to BLn from the selected memory cells.

During the read operation, the first to n-th page buffers PB1 to PBn may sense the data DATA from the memory cells of the selected page through the first to n-th bit lines BL1 to BLn, and output the read data DATA to the input/output circuit 125 under the control of the column decoder 124.

During the erase operation, the first to n-th page buffers PB1 to PBn may float the first to n-th bit lines BL1 to BLn.

During an operation of loading the map entry, the first to n-th page buffers PB1 to PBn may sense all of the plurality of map entries stored in the memory cell array 110 or some map entries among the plurality of map entries. The first to n-th page buffers PB1 to PBn may temporarily store the sensed map entries. The temporarily stored map entries may be transmitted to the memory controller 200 through the input/output circuit 125.

The column decoder 124 may transfer data between the input/output circuit 125 and the page buffer group 123 in response to a column address CADD. For example, the column decoder 124 may exchange data with the page buffers PB1 to PBn through data lines DL, or may exchange data with the input/output circuit 125 through column lines CL.

The input/output circuit 125 may transfer the command CMD and the address ADD received from the memory controller 200 to the control logic 130, or may exchange data DATA with the column decoder 124.

During the read operation or the verify operation, the sensing circuit 126 may generate a reference current in response to a permission bit signal VRY_BIT<#> and compare a sensing voltage VPB received from the page buffer group 123 with a reference voltage generated by the reference current to output a pass signal PASS or a fail signal FAIL.

The control logic 130 may be connected to the voltage generator 121, the row decoder 122, the page buffer group 123, the column decoder 124, the input/output circuit 125, and the sensing circuit 126.

The control logic 130 may operate in response to the command CMD provided from the outside.

For example, the control logic 130 may output the operation command OP_CMD, the row address RADD, the page buffer control signals PBSIGNALS, and the permission bit VRY_BIT<#> in response to the command CMD and the address ADD to control the peripheral circuit 120.

The control logic 130 may determine whether the verify operation is passed or failed in response to the pass signal PASS or the fail signal FAIL output from the sensing circuit 126.

In an embodiment, the control logic 130 may store data DATA received from the memory controller 200 in the page buffer group 123 under the control of the memory controller 200.

The control logic 130 may program the write data or the map entry stored in the page buffers PB1 to PBn in the memory cell array 110 under the control of the memory controller 200.

For example, when receiving a map data flush command (not shown) instructing to store the map entry from the memory controller 200, the control logic 130 may program the map entries, which are stored in the page buffers PB1 to PBn, in the memory cell array 110 in response to the map data flush command.

The control logic 130 may read the map entry stored in the memory cell array 110 under the control of the memory controller 200.

For example, the memory controller 200 may provide the map read command commanding to read the map entries to the nonvolatile memory device 100. The control logic 130 may read some map entries among the plurality of map entries stored in the memory cell array 110 in response to the map read command, and provide the read some map entries to the memory controller 200 through the input/output circuit 125. In addition, the control logic 130 may read some map entries among the plurality of map entries stored in the memory cell array 110 in response to the map read command, store the read some map entries in the page buffers PB1 to PBn, and provide the read some map entries stored in the page buffers PB1 to PBn to the memory controller 200 through the input/output circuit 125.

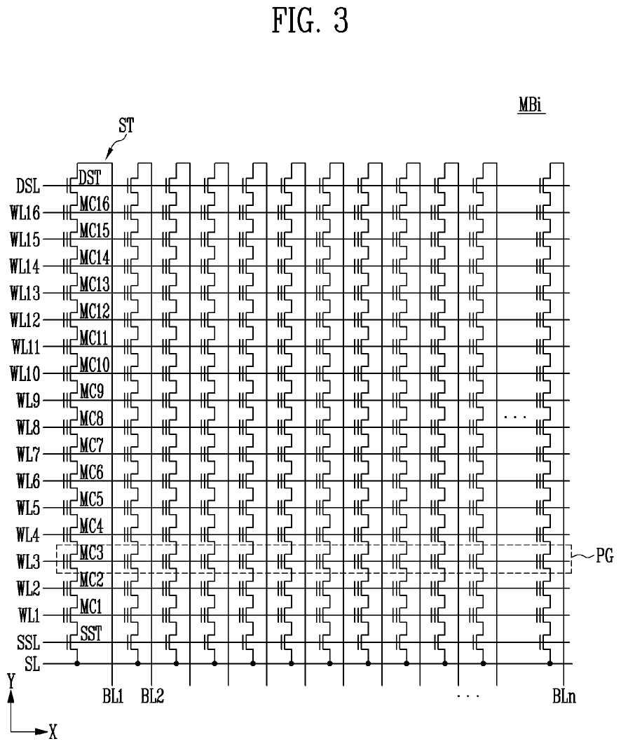

FIG. 3 is a diagram illustrating an embodiment of a memory block.

Referring to FIG. 3, the memory block MBi shown in FIG. 3 may be any one of the memory blocks MB1 to MBk of FIG. 2.

The memory block MBi may include a first select line, a second select line, a plurality of word lines WL1 to WL16, a source line SL, a plurality of bit lines BL1 to BLn, and a plurality of strings ST.

The first select line may be, for example, a source select line SSL. Hereinafter, it is assumed that the first select line is the source select line SSL.

The second select line may be, for example, a drain select line DSL. Hereinafter, it is assumed that the second select line is the drain select line DSL.

The plurality of word lines WL1 to WL16 may be arranged in parallel between the source select line SSL and the drain select line DSL.

The number of word lines WL1 to WL16 shown in FIG. 3 is an example, and is not limited to that shown in the drawing.

The source line SL may be commonly connected to the plurality of strings ST.

The plurality of bit lines BL1 to BLn may be connected to the strings ST, respectively.

The plurality of strings ST may be connected to the bit lines BL1 to BLn and the source line SL.

Since the strings ST may be configured to be identical to each other, the string ST connected to the first bit line BL1 is specifically described as an example.

The string ST may include a plurality of memory cells MC1 to MC16, at least one first select transistor, and at least one second select transistor.

The plurality of memory cells MC1 to MC16 may be connected in series between a source select transistor SST and a drain select transistor DST.

Gates of the memory cells MC1 to MC16 may be connected to the plurality of word lines WL1 to WL16, respectively. Therefore, the number of memory cells MC1 to MC16 included in one string ST may be the same as the number of word lines WL1 to WL16.

Any one of the plurality of memory cells MC1 to MC16 may be configured of any one of an single-level cell (SLC), an multi-level cell (MLC), a triple-level cell (TLC), and a quad-level cell (QLC).

A group of memory cells connected to the same word line among memory cells included in different strings ST may be referred to as a physical page PG. Therefore, the memory block MBi may include the physical pages PG corresponding to the number of word lines WL1 to WL16. Hereinafter, it is assumed that memory cells (for example, MC3) included in the physical page PG are selected memory cells.

The first select transistor may be, for example, a source select transistor SST. Hereinafter, it is assumed that the first select transistor is the source select transistor SST.

A first electrode of the source select transistor SST may be connected to the source line SL. A second electrode of the source select transistor SST may be connected to the first memory cell MC1 among the plurality of memory cells MC1 to MC16. A gate electrode of the source select transistor SST may be connected to the source select line SSL.

The second select transistor may be, for example, a drain select transistor DST. Hereinafter, it is assumed that the second select transistor is the drain select transistor DST.

A first electrode of the drain select transistor DST may be connected to the sixteenth memory cell MC16 among the plurality of memory cells MC1 to MC16. A second electrode of the drain select transistor DST may be connected to the first bit line BL1. A gate electrode of the drain select transistor DST may be connected to the drain select line DSL.

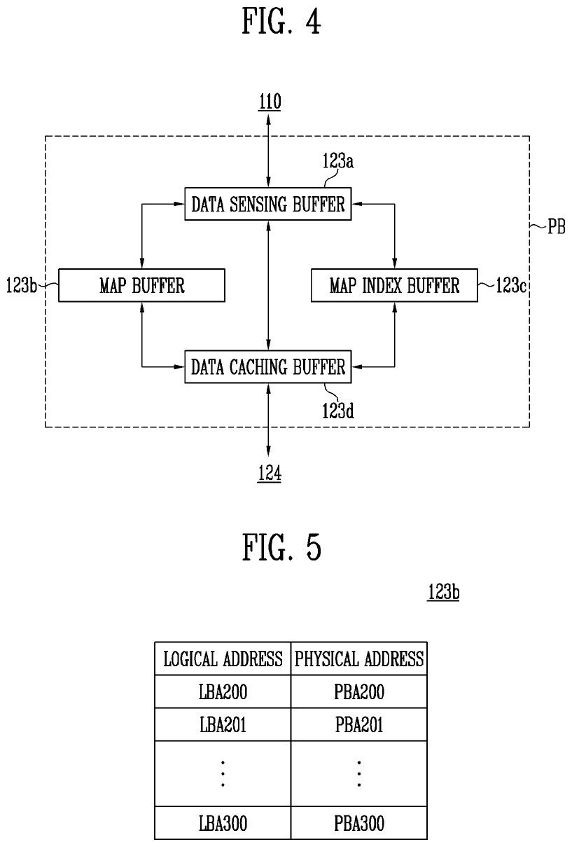

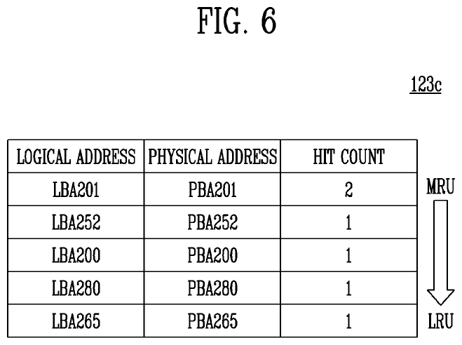

FIG. 4 is a diagram illustrating a page buffer according to an embodiment of the present disclosure, FIG. 5 is a diagram illustrating a map buffer shown in FIG. 4, and FIG. 6 is a diagram illustrating a map index buffer shown in FIG. 4.

Referring to FIG. 4, the page buffer PB shown in FIG. 4 may be any one of the first to n-th page buffers PB1 to PBn shown in FIG. 2.

The page buffer PB may include a data sensing buffer 123a, a map buffer 123b, a map index buffer 123c, and a data caching buffer 123d.

The data sensing buffer 123a may sense the read data or temporarily store the write data. For example, during the read operation, the data sensing buffer 123a may sense a potential or a current amount of the bit lines BL1 to BLm, and temporarily store the sensed read data. Alternatively, the data sensing buffer 123a may adjust a potential level of the bit lines BL1 to BLm according to the write data temporarily stored during the program operation.

The map buffer 123b may store first map entries among the plurality of map entries. The first map entry may mean a map entry stored in the map buffer 123b. Referring to FIG. 5, for example, the map buffer 123b may store the first map entries respectively indicating a mapping relationship between logical addresses LBA200 to LBA300 and physical addresses PBA200 to PBA300. Any one of the first map entries may be data indicating a mapping relationship between the 200th logical address LBA200 and the 200th physical address PBA200.

The map index buffer 123c may store second map entries arranged based on a hit count among the first map entries (for example, data indicating the mapping relationship between the logical addresses LBA200 to LBA300 and the physical addresses PBA200 to PBA300, respectively). Here, the second map entry may mean a map entry stored in the map index buffer 123c. The hit count may be the number of times a map entry corresponding to a logical address provided from the host 400 is hit. The hit of the map entry may mean that a physical address corresponding to the logical address provided from the host 400 is accessed.

Referring to FIG. 6, for example, the map index buffer 123c may store second map entries respectively indicating a mapping relationship between logical addresses LBA201, LBA252, LBA200, LBA280, and LBA265 and physical addresses PBA201, PBA252, PBA200, PBA280, and PBA265. The second map entries may be sequentially arranged according to a hit count as shown in FIG. 6. That is, the second map entries may be sorted in a descending order of the hit count. However, the present disclosure is not limited thereto.

The second map entry having the largest hit count among the second map entries may correspond to most recently used (MRU), and the second map entry having the smallest hit count among the second map entries may correspond to least recently used (LRU). Referring to FIG. 6, for example, since the hit count of the second map entry indicating the mapping relationship between the 201st logical address LBA201 and the 201st physical address PBA201 is the largest, the second map entry indicating the mapping relationship between the 201st logical address LBA201 and the 201st physical address PBA201 may correspond to the MRU. Since the hit count of the second map entry indicating the mapping relationship between the 265th logical address LBA265 and the 265th physical address PBA265 is the smallest, the second map entry indicating mapping relationship between the 265th logical address LBA265 and the 265th physical address PBA265 may correspond to the LRU.

When the memory controller 200 searches for a search map entry in the map index buffer 123c, a search order may be an order in which the second map entries are sequentially searched from the second map entry having the largest hit count to the second map entry having the smallest hit count. That is, the search order may be a descending order of the hit count. Referring to FIG. 6, for example, an order of searching for the map entry corresponding to the logical address corresponding to the host 400 may be an order of starting from the MRU and lasting the LRU. Here, the search map entry may be the map entry corresponding to the logical address provided from the host 400.

The data caching buffer 123d may transmit the write data to the data sensing buffer 123a or transmit the temporarily stored read data to the memory controller 200. For example, during the program operation, the data caching buffer 123d may temporarily store the write data received from the outside and transmit the temporarily stored write data to the data sensing buffer 123a. Alternatively, during the read operation, the data caching buffer 123d may receive the read data sensed from the data sensing buffer 123a and transmit the read data to the outside.

In an embodiment, the memory controller 200 may search whether the search map entry corresponding to the logical address provided from the host 400 is stored in the page buffer PB in an order of the map index buffer 123c and the map buffer 123b.

Specifically, for example, the memory controller 200 may first search for the search map entry in the map index buffer 123c. To this end, the memory controller 200 may provide a first map read command to the nonvolatile memory device 100. The first map read command may be a command commanding to read the second map entries stored in the map index buffer 123c. In this case, the second map entries may be provided to the memory controller 200. The memory controller 200 may search for the search map entry based on whether the second map entry corresponding to the logical address provided from the host 400 is present among the second map entries. At this time, as shown in FIG. 6, the memory controller 200 may first search for the search map entry from the second map entry corresponding to the MRU, and may search for the second map entry corresponding to the LRU last.

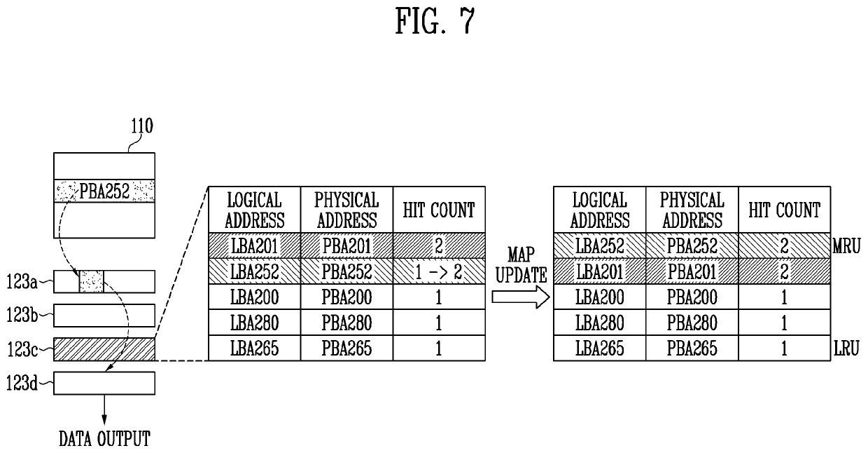

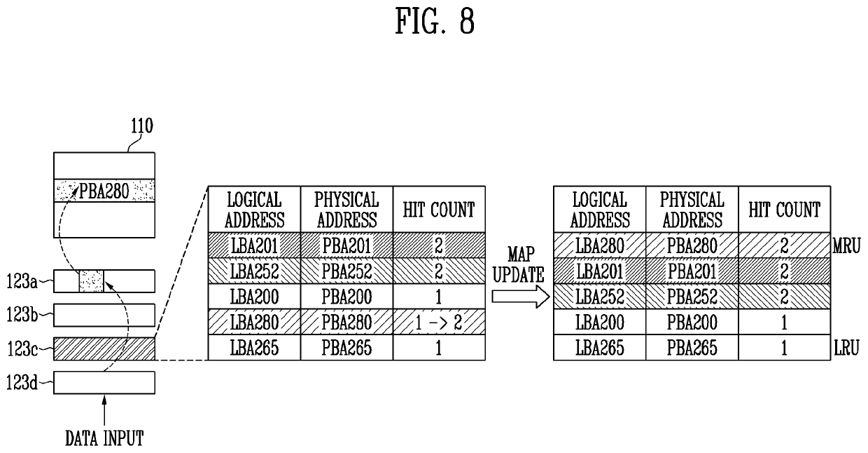

When the search map entry is searched in the map index buffer 123c, the memory controller 200 may perform a map update operation of controlling the nonvolatile memory device 100 to rearrange the second map entries. A description of this is described later with reference to FIGS. 7 and 8.

When the search map entry is not searched in the map index buffer 123c, the memory controller 200 may search whether the search map entry is stored in the map buffer 123b based on the first map entry. To this end, the memory controller 200 may provide a second map read command to the nonvolatile memory device 100. The second map read command may be a command commanding to read the first map entries stored in the map buffer 123b.

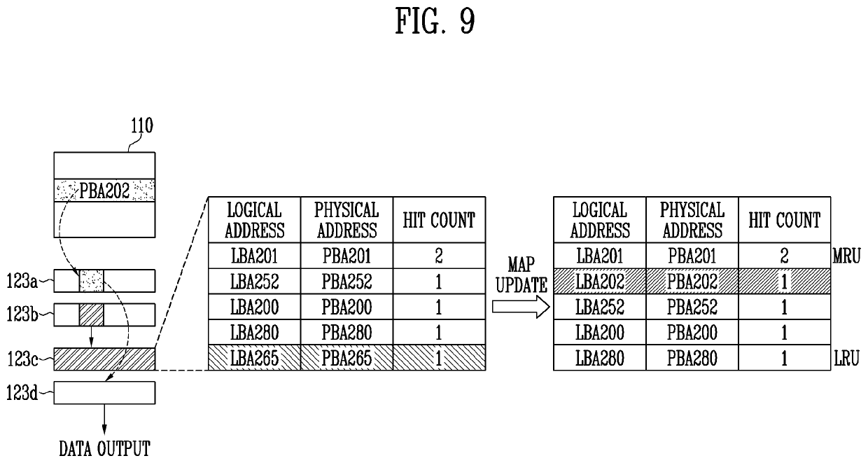

When the search map entry is searched in the map buffer 123b, the memory controller 200 may control the nonvolatile memory device 100 to store the first map entry corresponding to the search map entry as the second map entry in the map index buffer 123c. Accordingly, the memory controller 200 may perform a map update operation of controlling the nonvolatile memory device 100 to rearrange the second map entries. A description of this is described later with reference to FIG. 9.

In an embodiment, when the search map entry is searched in the page buffer PB, the memory controller 200 may convert the logical address provided from the host 400 to the physical address based on the search map entry.

FIG. 7 is a diagram illustrating an embodiment of performing a map update according to an embodiment of the present disclosure, and FIG. 8 is a diagram illustrating another embodiment of performing a map update according to an embodiment of the present disclosure.

Referring to FIGS. 6 to 8, the map index buffer 123c may store second map entries respectively indicating a mapping relationship between logical addresses LBA201, LBA252, LBA200, LBA280, and LBA265 and physical addresses PBA201, PBA252, PBA200, PBA280, and PBA265.

Here, it is assumed that the hit count of the second map entry indicating the mapping relationship between the 201st logical address LBA201 and the 201st physical address PBA201 is the highest as 2 and the second map entry is the MRU, and it is assumed that the hit count of the second map entry indicating the mapping relationship between the 265th logical address LBA265 and the 265th physical address PBA265 is the lowest as 1 and the second map entry is the LRU.

Referring to FIG. 7, when the logical address provided from the host 400 is the 252nd logical address LBA252 and the host 400 provides the read request to the memory controller 200, the memory controller 200 may search a search map entry corresponding to the 252nd logical address LBA252 in the map index buffer 123c. In this case, since the search map entry corresponding to the 252nd logical address LBA252 is stored in the map index buffer 123c, the memory controller 200 may convert the 252nd logical address LBA252 into the 252nd physical address PBA252. In addition, the memory controller 200 may provide the 252nd physical address PBA252 and the read command to the nonvolatile memory device 100.

The nonvolatile memory device 100 may output read data stored in the 252nd physical address PBA252 in response to the read command. For example, the read data stored in the 252nd physical address PBA252 of the memory cell array 110 is temporarily stored in the data sensing buffer 123a, and the read data temporarily stored in the data sensing buffer 123a may be output to the memory controller 200 through the data caching buffer 123d.

In an embodiment, when the search map entry is searched in the map index buffer 123c, the memory controller 200 may increase the hit count of the second map entry corresponding to the search map entry among the second map entries. In addition, the memory controller 200 may control the nonvolatile memory device 100 to rearrange the second map entries as the hit count of the second map entry increases.

Referring to FIG. 7, for example, as the read data is output, the hit count of the second map entry indicating the mapping relationship between the 252nd logical address LBA252 and the 252nd physical address PBA252 may be increased from 1 to 2. In addition, since the hit count of the second map entry indicating the mapping relationship between the 252nd logical address LBA252 and the 252nd physical address PBA252 is increased, the second map entries may be rearranged in a descending order.

In an embodiment, when the increased hit count of the second map entry is equal to the largest hit count, the memory controller 200 may control the nonvolatile memory device 100 so that the increased second map entry is searched prior to the second map entry having the largest hit count.

Referring to FIG. 7, for example, the hit count of the second map entry indicating the mapping relationship between the 201st logical address LBA201 and the 201st physical address PBA201 may be 2. In addition, the hit count of the second map entry indicating the mapping relationship between the 252nd logical address LBA252 and the 252nd physical address PBA252 may also be 2. In this case, the second map entry indicating the mapping relationship between the 252nd logical address LBA252 and the 252nd physical address PBA252 may be arranged in preference to the second map entry indicating the mapping relationship between the 201st logical address LBA201 and the 201st physical address PBA201. For example, the second map entry indicating the mapping relationship between the 252nd logical address LBA252 and the 252nd physical address PBA252 may correspond to the MRU. The second map entry indicating the mapping relationship between the 201st logical address LBA201 and the 201st physical address PBA201 might not correspond to the MRU.

Referring to FIG. 8, when the logical address provided from the host 400 is the 280th logical address LBA280 and the host 400 provides the write request to the memory controller 200, the memory controller 200 may search for the search map entry corresponding to the address LBA280 in the map index buffer 123c. In this case, since the search map entry corresponding to the 280th logical address LBA280 is stored in the map index buffer 123c, the memory controller 200 may convert the 280th logical address LBA280 to the 280th physical address PBA280. In addition, the memory controller 200 may provide the 280th physical address PBA280, the program command, and the write data provided from the host 400 to the nonvolatile memory device 100.

The nonvolatile memory device 100 may program the write data to the 280th physical address PBA280 in response to the program command. For example, the data caching buffer 123d may transmit the write data to the data sensing buffer 123a, and adjust the potential level of the bit lines BL1 to BLm corresponding to the write data temporarily stored in the data sensing buffer 123a. The write data may be stored in the 280th physical address PBA280 of the memory cell array 110.

In an embodiment, when the search map entry is searched in the map index buffer 123c, the hit count of the second map entry corresponding to the search map entry is increased, and thus the second map entries may be rearranged.

Referring to FIG. 8, for example, as the write data is output, the hit count of the second map entry indicating the mapping relationship between the 280th logical address LBA280 and the 280th physical address PBA280 may be increased from 1 to 2. In addition, since the hit count of the second map entry indicating the mapping relationship between the 280th logical address LBA280 and the 280th physical address PBA280 is increased, the second map entries may be rearranged in a descending order. Each counts of the second map entry indicating the mapping relationship between the 201st logical address LBA201 and the 201st physical address PBA201, the second map entry indicating the mapping relationship between the 252nd logical address LBA252 and the 252nd physical address PBA252, and the second map entry indicating the mapping relationship between the 280th logical address LBA280 and the 280th physical address PBA280 may be the same. In this case, the second map entry indicating the mapping relationship between the 280th logical address LBA280 and the 280th physical address PBA280 may be arranged in the highest priority so as to correspond to the MRU.

FIG. 9 is a diagram illustrating still another embodiment of performing a map update according to an embodiment of the present disclosure.

Referring to FIGS. 5, 6, and 9, when the logical address provided from the host 400 is the 202nd logical address LBA202 and the host 400 provides the read request to the memory controller 200, the memory controller 200 may search for the search map entry corresponding to the 202nd logical address LBA202 in the map index buffer 123c. In this case, since the search map entry corresponding to the 202nd logical address LBA202 is not stored in the map index buffer 123c, the memory controller 200 may search for the map entry corresponding to the 202nd logical address LBA202 in the map buffer 123b. Since the search map entry corresponding to the 202nd logical address LBA202 is stored in the map buffer 123b, the memory controller 200 may convert the 202nd logical address LBA202 into the 202nd physical address PBA202. In addition, the memory controller 200 may provide the 202nd physical address PBA202 and the read command to the nonvolatile memory device 100.

The nonvolatile memory device 100 may output the read data stored in the 202nd physical address PBA202 in response to the read command. For example, the read data stored in the 202nd physical address PBA202 of the memory cell array 110 may be temporarily stored in the data sensing buffer 123a, and the read data temporarily stored in the data sensing buffer 123a may be output to the memory controller 200 through the data caching buffer 123d.

In an embodiment, when the search map entry is searched in the map buffer 123b, the memory controller 200 may control the nonvolatile memory device 100 to store the first map entry corresponding to the search map entry among the first map entries as the second map entry in the map index buffer 123c. The hit count of the stored search map entry may be increased, and thus the second map entries may be rearranged. When the first map entry corresponding to the search map entry is stored in the map index buffer 123c, the page buffer PB may delete the map entry having the smallest hit count among the second map entries from the map index buffer.

Referring to FIG. 9, for example, as the read data is output, the map entry indicating the mapping relationship between the 202nd logical address LBA202 and the 202nd physical address PBA202 may be stored in the map index buffer 123c. The hit count of the map entry indicating the mapping relationship between the 202nd logical address LBA202 and the 202nd physical address PBA202 may be set to 1. In addition, the second map entries may be rearranged in a descending order. As shown in FIG. 9, the map entry indicating the mapping relationship between the 202nd logical address LBA202 and the 202nd physical address PBA202 may be arranged in a next order of the second map entry indicating the mapping relationship between the 201st logical address LBA201 and the 201st physical address PBA201. As the map entry indicating the mapping relationship between the 202nd logical address LBA202 and the 202nd physical address PBA202 is stored, the page buffer PB may delete the second map entry corresponding to the LRU, for example, the second map entry indicating the mapping relationship between the 265th logical address LBA265 and the 265th physical address PBA265.

Although not shown, even in a case where the host 400 transmits the write request to the memory controller 200, the search map entry searched in the map buffer 123b may be stored in the map index buffer 123c. Therefore, the second map entries may be rearranged, and the second map entry corresponding to the LRU may be deleted.

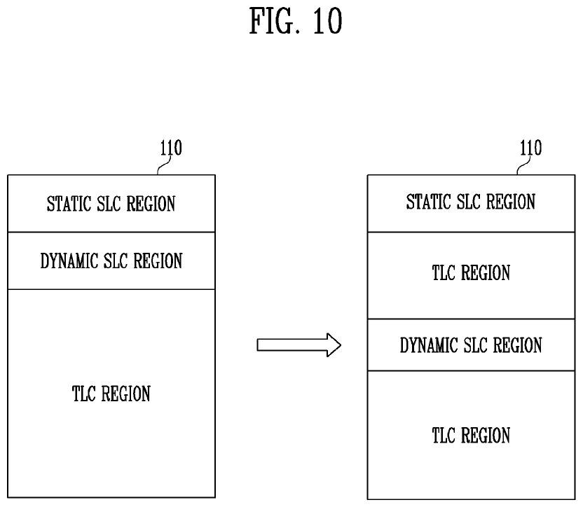

FIG. 10 is a diagram illustrating region division of a memory cell array according to a program operation.

Referring to FIGS. 1 and 10, during the program operation, the memory cell array 110 may divide a storage space into a static SLC region, a dynamic SLC region, and a TLC region according to a program method.

For example, the static SLC region and the dynamic SLC region are regions programmed in an SLC program method during the program operation, and the TLC region is a region programmed in a TLC program method during the program operation.

The static SLC region may a region formed of an SLC, and may be a region fixed by a set data capacity of the memory cell array 110. The dynamic SLC region may be a region formed of the SLC identically to the static SLC region, but may be a region variable according to a capacity of data to be programmed differently from the static SLC region. The dynamic SLC region may be changed to the TLC region as needed, such as a case where a storage space is insufficient. Accordingly, the dynamic SLC region may be adjacent to the static SLC region or may be disposed between static SLC region and the TLC region.

After receiving data to be programmed in order to improve a program operation speed and stability during the program operation, the storage device 1000 may program the received data in the static SLC region or the dynamic SLC region in the SLC program method. During the background operation of the storage device 1000, the data stored in the static SLC region or the dynamic SLC region may be read, and the read data may be programmed in the TLC region. An operation of programming the data, which is stored in the SLC region or the dynamic SLC region, in the TLC region may be defined as a merge operation.

The TLC region may be a region formed of a TLC. A portion of the TLC region may be changed to the dynamic SLC region as needed, such as a program operation speed.

As a result, the program operation speed and data reliability may be improved by performing the program operation in the SLC program method when the data received from the outside is programmed, and data storage efficiency may be improved by programming the data, which is stored in the static SLC region or the dynamic SLC region, in the TLC program method during the background operation (for example, the garbage collection).

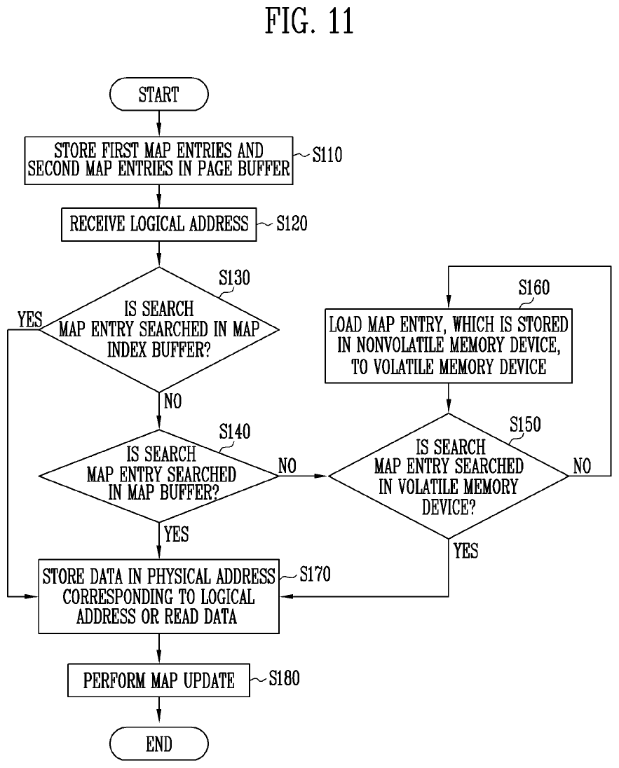

FIG. 11 is a flowchart illustrating a method of operating a storage device according to an embodiment of the present disclosure.

Referring to FIG. 11, the nonvolatile memory device 100 stores the first map entries and the second map entries in the page buffer (S110). For example, the nonvolatile memory device 100 may read the first map entries and the second map entries among the plurality of entries stored in the memory cell array 110 in response to the control of the memory controller 200, store the first map entries in the map buffer 123b included in each of the page buffers PB1 to PBn, and sequentially store the second map entries in the map index buffer 123c included in each of the page buffers PB1 to PBn according to the hit count.

The memory controller 200 may receive the logical address from the host 400 (S120).

The memory controller 200 searches for the search map entry corresponding to the logical address received from the host 400 in the map index buffer 123c (S130). For example, the memory controller 200 may determine whether the second map entry corresponding to the search map entry is present among the second map entries sequentially from the second map entry having the largest hit count to the second map entry having the smallest hit count.

When the search map entry is not searched in the map index buffer 123c (S130, NO), the memory controller 200 searches for the search map entry in the map buffer 123b (S140).

When the search map entry is not searched in the map buffer 123b (S140, NO), the memory controller 200 searches for the search map entry in the volatile memory device 300 (S150). For example, the memory controller 200 determines whether the search map entry is stored in the map caching buffer 320 included in the volatile memory device 300.

When the search map entry is not searched in the volatile memory device 300 (S150, NO), the memory controller 200 may load the map entry stored in the nonvolatile memory device 100 to the volatile memory device 300 (S160), and after the map entry stored in the nonvolatile memory device 100 is loaded to the volatile memory device 300, step S150 is performed.

When the search map entry is searched in the map index buffer 123c (S130, YES), the memory controller 200 may convert the logical address provided from the host 400 to the physical address based on the search map entry, and store the data in the physical address or read the data stored in the physical address (S170).

When the search map entry is searched in the map buffer 123b (S140, YES), step S170 is performed. In addition, when the search map entry is searched in the volatile memory device 300 (S150, YES), step S170 is performed.

The memory controller 200 may perform the map update as the data is stored or read (S180). For example, the memory controller 200 may increase the hit count of the second map entry corresponding to the search map entry among the second map entries, and rearrange the second map entries stored in the map index buffer 123c as the hit count of the second map entry increases.

In an embodiment, when the increased hit count of the updated second map entry is equal to the largest hit count, the storage device 1000 may arrange the increased second map entry in the highest priority order in the map index buffer 123c so that the increased second map entry is searched prior to the second map entry having the largest hit count.

In an embodiment, when the search map entry is searched in the map buffer 123b (S140, YES), the memory controller 200 may control the nonvolatile memory device 100 to store the first map entry corresponding to the search map entry among the first map entries as the second map entry in the map index buffer 123c.

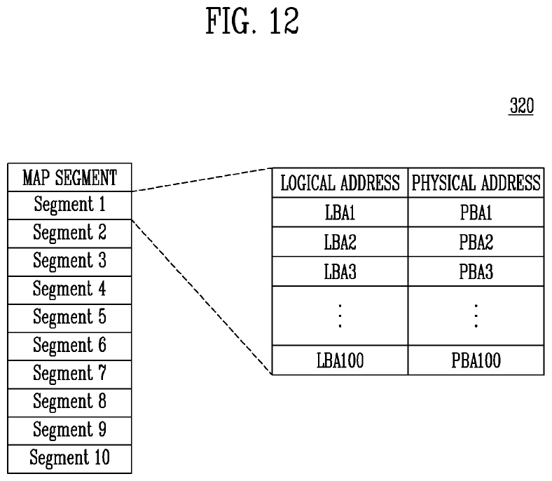

FIG. 12 is a diagram illustrating a map caching buffer according to an embodiment of the present disclosure.

Referring to FIGS. 1 and 12, the map caching buffer 320 included in the volatile memory device 300 may store a plurality of map segments Segment 1 to Segment 10. Here, the number of the plurality of map segments Segment 1 to Segment 10 shown in FIG. 12 is only for describing an embodiment of the present disclosure, but is not limited thereto.

One map segment may include a plurality of map entries. Referring to FIG. 12, for example, the first map segment Segment 1 may include 100 map entries. One map entry may be data indicating the mapping relationship between the first logical address LBA1 and the first physical address PBA1. Another map entry may be data indicating the mapping relationship between the second logical address LBA2 and the second physical address PBA2. Still another map entry may be data indicating the mapping relationship between the third logical address LBA3 and the third physical address PBA3. Further still another map entry may be data indicating the mapping relationship between the 100th logical address LBA100 and the 100th physical address PBA100.

In an embodiment, the search map entry might not be stored in the map buffer 123b and the map index buffer 123c. In this case, the memory controller 200 may search for the search map entry in the volatile memory device 300. That is, the memory controller 200 may check whether the search map entry is stored in the volatile memory device 300.

For example, when the search map entry is not searched in the page buffer PB, the memory controller 200 may search whether the search map entry is stored in the map caching buffer 320 with reference to the plurality of map segments Segment 1 to Segment 10 stored in the map caching buffer 320.

In an embodiment, when the search map entry is not searched in the volatile memory device 300, the memory controller 200 may control the nonvolatile memory device 100 to read new map entries among the plurality of map entries stored in the nonvolatile memory device 100. In this case, the nonvolatile memory device 100 may read the new map entries among the plurality of map entries and transmit the newly read map entries to the memory controller 200 in response to the control of the memory controller 200. The memory controller 200 may store the newly read map entries in the volatile memory device 300.

In an embodiment, when the search map entry is not searched in the volatile memory device 300, the memory controller 200 may control the nonvolatile memory device 100 to store the new map entries among the plurality of map entries stored in the nonvolatile memory device 100 in the map buffer 123b.

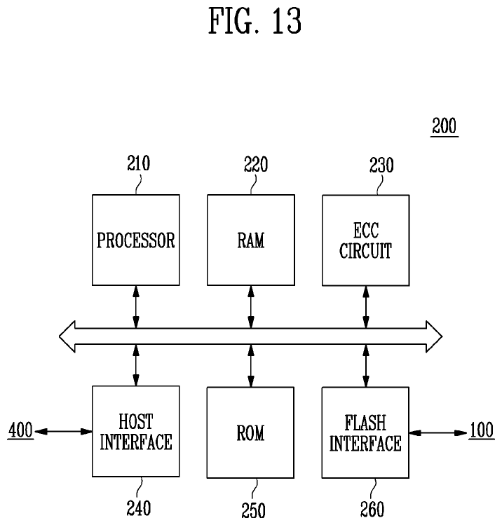

FIG. 13 is a diagram illustrating a memory controller according to an embodiment of the present disclosure.

Referring to FIGS. 1 and 13, the memory controller 200 may include a processor 210, a RAM 220, an error correction circuit 230, a host interface 240, a ROM 250, and a flash interface 260.

The processor 210 may control an overall operation of the memory controller 200.

The RAM 220 may be used as a buffer memory, a cache memory, an operation memory, and the like of the memory controller 200. For example, the RAM 220 may be a buffer memory.

The error correction circuit 230 may generate an error correction code (ECC) for correcting a fail bit or an error bit of data received from the nonvolatile memory device 100.

The error correction circuit 230 may perform error correction encoding of data provided to the nonvolatile memory device 100 to generate data to which a parity bit is added. The parity bit (not shown) may be stored in the nonvolatile memory device 100.

The error correction circuit 230 may perform error correction decoding on the data output from the nonvolatile memory device 100, and at this time, the error correction circuit 230 may correct an error using parity.

For example, the error correction circuit 230 may correct the error using various coded modulations such as an LDPC code, a BCH code, a turbo code, a Reed-Solomon code, a convolution code, an RSC, a TCM, and a BCM.

The error correction circuit 230 may calculate an error correction code value of data to be programmed to the nonvolatile memory device 100 in the program operation.

The error correction circuit 230 may perform an error correction operation based on the error correction code value on data read from the nonvolatile memory device 100 in the read operation.

The error correction circuit 230 may perform an error correction operation of data recovered from the nonvolatile memory device 100 in a recovery operation of failed data.

The memory controller 200 may communicate with an external device (for example, the host 400, an application processor, and the like) through the host interface 240.

The ROM 250 may store various pieces of information required to operate the memory controller 200 in a firmware form.

The memory controller 200 may communicate with the nonvolatile memory device 100 through the flash interface 260. The memory controller 200 may transmit the command, the address, a control signal, and the like to the nonvolatile memory device 100 and receive data through the flash interface 260.

For example, the flash interface 260 may include a NAND interface.

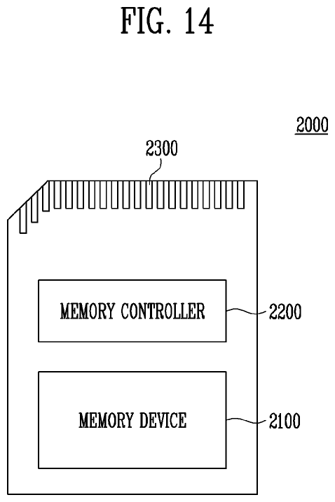

FIG. 14 is a block diagram illustrating a memory card system to which a storage device according to an embodiment of the present disclosure is applied.

Referring to FIGS. 1 and 14, the memory card system 2000 includes a memory device 2100, a memory controller 2200, and a connector 2300.

For example, the memory device 2100 may be configured of various nonvolatile memory elements such as an electrically erasable and programmable ROM (EEPROM), a NAND flash memory, a NOR flash memory, a phase-change RAM (PRAM), a resistive RAM (ReRAM), a ferroelectric RAM (FRAM), and a spin-transfer torque magnetoresistive RAM (STT-MRAM).

The memory controller 2200 is connected to the memory device 2100. The memory controller 2200 is configured to access the memory device 2100. For example, the memory controller 2200 may be configured to control read, write, erase, and background operations of the memory device 2100. The memory controller 2200 is configured to provide an interface between the memory device 2100 and the host 400. The memory controller 2200 is configured to drive firmware for controlling the memory device 2100. The memory controller 2200 may be implemented equally to the memory controller 200 described with reference to FIG. 1.

For example, the memory controller 2200 may include components such as a random access memory (RAM), a processor, a host interface, a memory interface, and an error correction circuit.

The memory controller 2200 may communicate with an external device through the connector 2300. The memory controller 2200 may communicate with an external device (for example, the host 400) according to a specific communication standard. For example, the memory controller 2200 is configured to communicate with an external device through at least one of various communication standards such as a universal serial bus (USB), a multimedia card (MMC), an embedded MMC (eMMC), a peripheral component interconnection (PCI), a PCI express (PCI-E), an advanced technology attachment (ATA), a serial-ATA, a parallel-ATA, a small computer system interface (SCSI), an enhanced small disk interface (ESDI), integrated drive electronics (IDE), FireWire, a universal flash storage (UFS), Wi-Fi, Bluetooth, and an NVMe. For example, the connector 2300 may be defined by at least one of the various communication standards described above.

The memory device 2100 and the memory controller 2200 may be integrated into one semiconductor device to configure a memory card. For example, the memory controller 2200 and the memory device 2100 may be integrated into one semiconductor device to configure a memory card such as a PC card (personal computer memory card international association (PCMCIA)), a compact flash card, a smart media card (SM or SMC), a memory stick, a multimedia card (MMC, RS-MMC, MMCmicro, or eMMC), an SD card (SD, miniSD, microSD, or SDHC), and a universal flash storage (UFS).

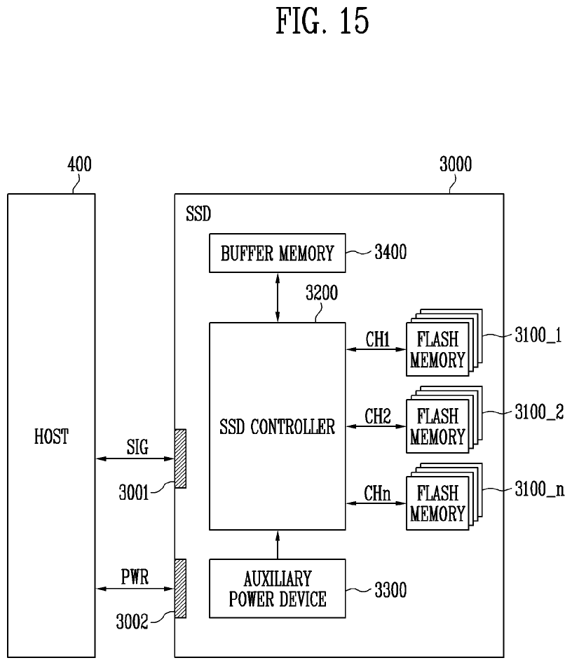

FIG. 15 is a block diagram illustrating a solid state drive (SSD) system to which a storage device according to an embodiment of the present disclosure is applied.

Referring to FIGS. 1 and 15, the SSD system includes the host 400 and an SSD 3000.

The SSD 3000 exchanges a signal SIG with the host 400 through a signal connector 3001 and receives power PWR through a power connector 3002. The SSD 3000 includes an SSD controller 3200, a plurality of flash memories 3100_1, 3100_2, and 3100_n, an auxiliary power device 3300, and a buffer memory 3400.

According to an embodiment of the present disclosure, the SSD controller 3200 may perform the function of the memory controller 200 described with reference to FIG. 1.

The SSD controller 3200 may control the plurality of flash memories 3100_1, 3100_2, and 3100_n in response to the signal SIG received from the host 400. For example, the signal SIG may be signals based on an interface between the host 400 and the SSD 3000. For example, the signal SIG may be a signal defined by at least one of interfaces such as a universal serial bus (USB), a multimedia card (MMC), an embedded MMC (eMMC), a peripheral component interconnection (PCI), a PCI express (PCI-E), an advanced technology attachment (ATA), a serial-ATA, a parallel-ATA, a small computer system interface (SCSI), an enhanced small disk interface (ESDI), integrated drive electronics (IDE), FireWire, a universal flash storage (UFS), Wi-Fi, Bluetooth, and an NVMe.

The auxiliary power device 3300 is connected to the host 400 through the power connector 3002. The auxiliary power device 3300 may receive the power PWR from the host 400 and may charge the power. The auxiliary power device 3300 may provide power of the SSD 3000 when power supply from the host 400 is not smooth. For example, the auxiliary power device 3300 may be positioned in the SSD 3000 or may be positioned outside the SSD 3000. For example, the auxiliary power device 3300 may be positioned on a main board and may provide auxiliary power to the SSD 3000.

The buffer memory 3400 may temporarily store data. For example, the buffer memory 3400 may temporarily store data received from the host 400 or data received from the plurality of flash memories 3100_1, 3100_2, and 3100_n, or may temporarily store meta data (for example, a mapping table) of the flash memories 3100_1, 3100_2, and 3100_n. The buffer memory 3400 may include a volatile memory such as a DRAM, an SDRAM, a DDR SDRAM, an LPDDR SDRAM, and a GRAM, or a nonvolatile memory such as an FRAM, a ReRAM, an STT-MRAM, and a PRAM.

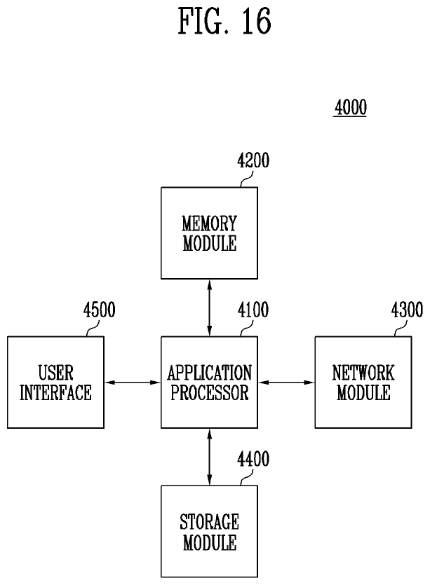

FIG. 16 is a block diagram illustrating a user system to which a storage device according to an embodiment of the present disclosure is applied.

Referring to FIG. 16, the user system 4000 includes an application processor 4100, a memory module 4200, a network module 4300, a storage module 4400, and a user interface 4500.

The application processor 4100 may drive components, an operating system (OS), a user program, or the like included in the user system 4000. For example, the application processor 4100 may include controllers, interfaces, graphics engines, and the like that control the components included in the user system 4000. The application processor 4100 may be provided as a system-on-chip (SoC).

The memory module 4200 may operate as a main memory, an operation memory, a buffer memory, or a cache memory of the user system 4000. The memory module 4200 may include a volatile random access memory such as a DRAM, an SDRAM, a DDR SDRAM, a DDR2 SDRAM, a DDR3 SDRAM, an LPDDR SDARM, an LPDDR2 SDRAM, and an LPDDR3 SDRAM, or a nonvolatile random access memory, such as a PRAM, a ReRAM, an MRAM, and an FRAM. For example, the application processor 4100 and memory module 4200 may be packaged based on a package on package (POP) and provided as one semiconductor package.

The network module 4300 may communicate with external devices. For example, the network module 4300 may support wireless communication such as code division multiple access (CDMA), global system for mobile communications (GSM), wideband CDMA (WCDMA), CDMA-2000, time division multiple access (TDMA), long term evolution, Wimax, WLAN, UWB, Bluetooth, and Wi-Fi. For example, the network module 4300 may be included in the application processor 4100.

The storage module 4400 may store data. For example, the storage module 4400 may store data received from the application processor 4100. Alternatively, the storage module 4400 may transmit data stored in the storage module 4400 to the application processor 4100. For example, the storage module 4400 may be implemented with a nonvolatile semiconductor memory element such as a phase-change RAM (PRAM), a magnetic RAM (MRAM), a resistive RAM (RRAM), a NAND flash, a NOR flash, and a three-dimensional NAND flash. For example, the storage module 4400 may be provided as a removable storage device (removable drive), such as a memory card, and an external drive of the user system 4000.

For example, the storage module 4400 may operate identically to the storage device 1000 described with reference to FIG. 1. The storage module 4400 may include a plurality of nonvolatile memory devices, and the plurality of nonvolatile memory devices may operate identically to the nonvolatile memory device 100 described with reference to FIG. 1.

The user interface 4500 may include interfaces for inputting data or an instruction to the application processor 4100 or for outputting data to an external device. For example, the user interface 4500 may include user input interfaces such as a keyboard, a keypad, a button, a touch panel, a touch screen, a touch pad, a touch ball, a camera, a microphone, a gyroscope sensor, a vibration sensor, and a piezoelectric element. The user interface 4500 may include user output interfaces such as a liquid crystal display (LCD), an organic light emitting diode (OLED) display device, an active matrix OLED (AMOLED) display device, an LED, a speaker, and a monitor.

What is claimed is:

1. A storage device comprising:
a non-volatile memory device including a non-volatile storage area configured to store a plurality of map entries and a page buffer group configured to sense data stored in the non-volatile storage area or temporality store data to be stored in the non-volatile storage area;
a volatile memory device including a map cache buffer configured to store part of map entries among the plurality of the map entries; and
a memory controller configured receive a read request and a logical address from an external host, translate the logical address to a physical address and obtain read data correspond to the read request;
wherein the page buffer group comprising:
a first volatile storage area configured to store first map entries different from map entries stored in the map cache buffer; and
a second volatile storage area configured to store second map entries including a plurality of map entries among the first map entries and a hit count corresponds to each second map entry; and
wherein the memory controller searches the physical address in response to the read request in an order of the second volatile storage area, the first volatile storage area and the map cache buffer.

2. The storage device of claim 1, wherein the memory controller searches the physical address in the second volatile storage area sequentially from the second map entry having a largest hit count to the second map entry having a smallest hit count among the second map entries.

3. The storage device of claim 2, wherein the hit count indicates a number of times the logical address provided from the external host is hit.

4. The storage device of claim 1, wherein when a search map entry including the physical address is searched in the first volatile storage area, the memory controller increases a hit count of the search map entry and controls the non-volatile memory device to store the search map entry in the second volatile storage area.

5. The storage device of claim 1, wherein when the physical address is not searched in the volatile memory device, the memory controller controls the non-volatile memory device to read new map entries among the map entries stored in the non-volatile storage area in the volatile memory device.
